(19) United States
(12) Patent Application Publication
(10) Pub. No.: US 2017/0152368 A1
(43) Pub. Date: Jun. 1, 2017

(54) RESIN COMPOSITION, MOLDED BODY, ELECTRONIC COMPONENT, ELECTRONIC APPARATUS, AND ELECTRONIC OFFICE APPARATUS

(71) Applicants: Yasushi AKIBA, Kanagawa (JP); Tadakatsu HARADA, Kanagawa (JP); Yasuo KURACHI, Tokyo (JP)

(72) Inventors: Yasushi AKIBA, Kanagawa (JP); Tadakatsu HARADA, Kanagawa (JP); Yasuo KURACHI, Tokyo (JP)

(73) Assignee: RICOH COMPANY, LTD., Tokyo (JP)

(21) Appl. No.: 15/357,034

(22) Filed: Nov. 21, 2016

(30) Foreign Application Priority Data
Nov. 27, 2015 (JP) 2015-232413

(51) Int. Cl. C08K 5/5399; C08L 69/00

(52) U.S. Cl. CPC C08K 5/5399; C08L 69/00; C08L 2201/02; C08L 2205/03

(57) ABSTRACT

Provided is a resin composition including a polycarbonate and a phosphorus-containing compound, wherein a content rate of the phosphorus-containing compound in the resin composition is less than 14 percent by mass, wherein the phosphorus-containing compound includes a phosphazene derivative represented by general formula (1) below and a phosphoric acid ester, wherein a content rate of the phosphazene derivative in the resin composition is 0.1 percent by mass or greater but less than 3.0 percent by mass, and wherein a resin specific gravity (D0) of the resin composition before burned in a UL94V test and a resin specific gravity (D1) of the resin composition after burned in the UL94V test satisfy a relationship of D1/D0>0.85,

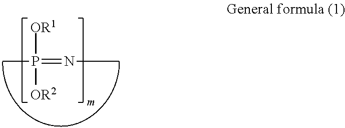

where in general formula (1), R¹ and R² each independently represent an aromatic ring-containing group free of a halogen atom, and m represents any of from 3 through 8.

### CROSS-REFERENCE TO RELATED APPLICATIONS

The present application claims priority under 35 U.S.C. §119 to Japanese Patent Application No. 2015-232413, filed Nov. 27, 2015. The contents of which are incorporated herein by reference in their entirety.

### BACKGROUND OF THE INVENTION

Field of the Invention

The present invention relates to a resin composition, a molded body, an electronic component, an electronic apparatus, and an electronic office apparatus.

Description of the Related Art

Polymers, which are typically organic substances, burn in a fire emergency. Hence, flame-retardant resins to which flame retardants are added are widely used as, for example, automobile materials, electric/electronic apparatus materials, housing materials, and materials for component production in other industrial fields.

Particularly, resin compositions that have passed a high flame retardancy standard “UL94-V0” are preferentially used as materials for information/mobile devices such as computers, notebook or laptop personal computers, tablet terminals, smart phones, and cellular phones and OA apparatuses such as printers and copiers.

In consideration of forms of use of electric/electronic apparatuses such as the information/mobile devices and OA apparatuses mentioned above, what are needed are not only flame retardancy that can tolerate burning of a resin caused by abnormal heating, but also shape retainability that prevents deformation of the resin until self-extinction if the resin should catch a fire. Moreover, not only such flame retardancy but also favorable mechanical properties such as impact strength resistance in particular are needed.

Examples of resins known to be used for realizing these properties include: polymer alloys obtained by adding ABS resins, polystyrene (PS) resins, or polymers extracted from natural products to polycarbonates that are widespread in the market because of easy availability of injection-molded products having favorable appearances; and resins obtained by adding fibrous reinforcing materials such as glass fiber to the polymer alloys mentioned above.

As methods for imparting flame retardancy to such polymer alloys and fiber-reinforced resin compositions, technical means of adding halogen-based flame retardants have been hitherto employed. However, resin compositions to which halogen-based flame retardants containing chlorine or bromine are added may be degraded in thermal stability or may corrode screws of molding machines or molding dies during molding processes.

Hence, in recent years, many methods of using organic phosphoric acid ester-based flame retardants instead of halogen-based flame retardants have been employed (see Japanese Unexamined Patent Application Publication No. 10-30056 and Japanese Unexamined Patent Application Publication No. 2006-176612).

However, it has been difficult for resin compositions containing polycarbonates to which organic phosphoric acid ester-based flame retardants are added to satisfy down gauging needs and high flame retardancy needs of recent years. There is another problem that impact resistance and stiffness of these resin compositions degrade considerably when the amounts of flame retardants to be added are increased in order to obtain a high flame retardancy.

Phosphazene derivatives, which are ones that can impart a high flame retardancy to polymer materials among organic phosphorus-based flame retardants, are poorly dispersible in polycarbonates. Therefore, there is a constraint that in production of resin compositions, phosphazene derivatives need to be previously prepared as masterbatches before dispersed in mixtures containing polycarbonates. This entails a problem that the production process becomes complicated (see Japanese Unexamined Patent Application Publication No. 2013-231140).

In response to these studies, there are proposed carbon fiber-reinforced polycarbonate resins in which organic phosphoric acid ester-based flame retardants are added together with carbon fiber (see Japanese Unexamined Patent Application Publication No. 09-48912, Japanese Unexamined Patent Application Publication No. 2000-226508, and Japanese Unexamined Patent Application Publication No. 2002-265767).

However, such carbon fiber-reinforced polycarbonate resins are also problematic in being poor in flame retardancy and heat resistance, and in addition, in being considerably poor in impact resistance. While many methods of using organic phosphorus-based flame retardants instead of halogen-based flame retardants have been studied, satisfactory flame retardant systems have not yet been found. Under such circumstances, there is proposed an attempt to use a phosphoric acid ester-based flame retardant in combination with a derivative in which a special cyclic phosphazene is linearly linked (see Japanese Translation of PCT international Application Publication No. JP-T-2005-501953).

There are modified products of polymers extracted from natural products (e.g., triacetylcellulose (TAC) and diacetylcellulose (DAC) obtained by modifying a side chain of cellulose, which is a polysaccharide, with acetic acid). Film formation techniques for forming films of these modified polymers have been developed for use as color photo films, and the field of use has expanded up until now to films for liquid crystals. In these fields of use, a high flame retardancy is also needed to qualify as home electric appliances. In addition, from environmental concerns, techniques of adding phosphoric acid ester-based flame retardants, which are plasticizers, have been developed in order to make polymers extrusion-moldable (see Japanese Unexamined Patent Application Publication No. 2014-9294 and Japanese Unexamined Patent Application Publication No. 2014-125513).

### SUMMARY OF THE INVENTION

According to one aspect of the present invention, a resin composition containing a polycarbonate and a phosphorus-containing compound is provided.

A content rate of the phosphorus-containing compound in the resin composition is less than 14 percent by mass.

The phosphorus-containing compound contains a phosphazene derivative represented by general formula (1) below and a phosphoric acid ester.

A content rate of the phosphazene derivative in the resin composition is 0.1 percent by mass or greater but less than 3.0 percent by mass.

A resin specific gravity (D0) of the resin composition before burned in a UL94V test and a resin specific gravity (D1) of the resin composition after burned satisfy a relationship of D1/D0>0.85.

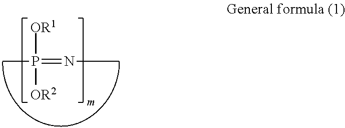

In general formula (1), R¹ and R² independently represent an aromatic ring containing group free of a halogen atom, and m represents any of 3 through 8.

### DESCRIPTION OF THE EMBODIMENTS

### (Resin Composition)

A resin composition of the present invention includes at least a polycarbonate and a phosphorus-containing compound, and further includes other components as needed.

A content rate of the phosphorus-containing compound in the resin composition is less than 14 percent by mass.

The phosphorus-containing compound contains a phosphazene derivative represented by general formula (1) below and a phosphoric acid ester.

A content rate of the phosphazene derivative in the resin composition is 0.1 percent by mass or greater but less than 3.0 percent by mass.

A resin specific gravity (D0) of the resin composition before burned in a UL94V test and a resin specific gravity (D1) of the resin composition after burned satisfy a relationship of D1/D0>0.85.

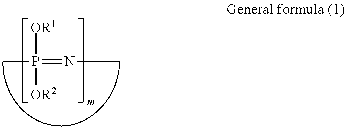

In general formula (1), R¹ and R² independently represent an aromatic ring-containing group free of a halogen atom, and m represents any of 3 through 8.

The present invention has an object to provide a resin composition excellent particularly in flame retardancy, stiffness, and impact resistance.

The present invention can provide a resin composition excellent particularly in flame retardancy, stiffness, and impact resistance.

The resin composition may hereinafter be referred to as flame-retardant resin composition.

The phosphorus-containing compound is a flame retardant.

There is a strong demand for resin compositions excellent in a balance among flame retardancy, stiffness, and mechanical properties such as impact resistance. However, it has not yet become possible, using phosphorus-based flame retardants, to obtain resin compositions that are applicable as exterior materials of electronic apparatuses and have excellent properties that prevent deformation even when the resin compositions are burned in a fire if the resin compositions should ever catch a fire.

In recent years, polycarbonate-based polymer alloys have been paid attention in order to produce resin compositions having a high flame retardancy. As a method for imparting flame retardancy to such resin compositions, what have been paid attention and have been developed are intumescent flame retardants that form a heat-resistant intumescent char layer to bring the resins to self-extinction. However, there has been a problem that the intumescent flame retardants may disturb functions of electronic apparatuses upon resin deformation following intumescence, even if the intumescent flame retardants have passed a burning test.

A phosphazene derivative presented in Japanese Translation of PCT International Application Publication No. JP-T-2005-501953 is a high-molecular-weight body in which ring structures are linked. There is a problem that when dispersed in a polymer, this phosphazene derivative cannot be compatibilized with the polymer, resulting in a dispersion failure.

Generally, phosphazene derivatives have a high flame retardancy, but are poorly dispersible in polymers linked via C—C bonds because structures of phosphazene derivatives are P═N skeletons.

The present invention has been made in view of these problems and has an object to provide a flame-retardant resin composition that is excellent in flame retardancy, stiffness, and impact resistance and that can sufficiently endure use in the form of a down-gauged molded body and tends not to deform even in case of a burning if a burning should occur. The present invention has another object to provide a molded body excellent in flame retardancy, stiffness, and impact resistance.

Among interior components of electronic office apparatuses, components that need to have high mechanical properties are formed of flame-retardant resins that have good mechanical properties and have passed a UL94-V2 test.

However, the UL94-V2 test can be passed even by flame-retardant resins that melt in a burning and come to self-extinction through endotherm that occurs when the melt drops off. These flame-retardant resins have a risk of not being able to come to self-extinction but igniting depending on shapes of molded bodies, positions of molded bodies in components, and positions of burning portions of molded bodies in a caught fire.

The present invention aims at a flame-retardant resin composition of a level of UL94-V0 in which the level of flame retardancy needed is higher than in the UL94-V2 test. The present invention also has an object to provide a technique of improving a flame retardancy level of a component in which the resin composition of the present invention is combined with a flame-retardant resin that is lower in flame retardancy level than the resin composition of the present invention.

As a result of earnest studies for solving the problems described above, the present inventors have conceived of a new system different from existing flame retardant systems and completed the present invention, concluding that these problems cannot be solved by the existing systems that intumesce in an actual fire burning to form a density-reduced char layer to cause deformation of components.

Specifically, what have been found as the present invention include: a method for imparting flame retardancy to a resin by a new flame retarding method that does not involve formation of an intumescent char layer resulting from density reduction due to an intumescent reaction that is the cause of deformation in a burning, to prevent a large change in density or specific gravity of the resin between before and after the burning, to prevent deformation of a molded body in the burning: and a technique for optimally disposing a resin molded body in a component in a manner to provide the component with a high flame retardancy when making the component by combining the resin composition of the present invention and another resin with each other.

To realize these techniques, an attempt was made to add a combination of a specific cyclic phosphazene derivative and a phosphoric acid ester in a specific amount to produce a flame-retardant resin. As a result, a technique capable of imparting a high flame retardancy to a resin without spoiling mechanical properties was found, to complete the present invention.

It was also found that the resin composition of the present invention produced by this technique tends not to deform at a high temperature. As a result of evaluating likelihood of deformation in a burning by a measure of deflection temperature under load (ASTM-D648) of a molded body, there was found a tendency that was correlated with this parameter in a manner that samples that had passed. UL94-V0 famous as a vertical test for qualifying highly flame-retardant resins measured high in this parameter.

Typically, heat resistance of resins is estimated based on glass transition temperature (Tg) at which elastic modulus of the resins sharply drops. It has been known that deflection temperature under load results in a value close to Tg for a reason related with the method for evaluating this parameter. For example, PS (polystyrene) has Tg of around 100 degrees C. and a deflection temperature under load of around 90 degrees C. PC (polycarbonate) has Tg of around 150 degrees C. and a deflection temperature under load of around 140 degrees C.

However, correlation between Tg and deflection temperature under load is not observed in flame-retardant resins to which flame retardants are added, because the flame retardants serve as plasticizers. Hence, correlation between samples having a high likelihood of deformation and these parameters was examined in the UL94 vertical test, and it was found that high flame retardancy and deflection temperature under load were correlated with each other.

That is, a flame-retardant resin mainly formed of PC, as an embodiment of the present invention, typically measures from 130 degrees C. through 150 degrees C. as Tg measured by DSC under a temperature elevating rate of 10 degrees C./min, and measures from 90 degrees C. through 140 degrees C. as a deflection temperature under load.

Hence, as regards the resin composition of the present invention, surprisingly, deformation of samples to occur in a burning test is correlated with deflection temperature under load. When this temperature is 90 degrees C. or higher, a high flame retardancy is obtained, and samples do not deform in a burning test. It has been known that static heat resistance is correlated with Tg. On the other hand, it has not been until the present invention that it is revealed that deflection temperature under load, which is a measure of a temperature at which deformation occurs under a load, and deformation in a burning test are correlated with each other.

As can be seen, the flame-retardant resin composition of the present invention not only has a high flame retardancy but also does not deform at a temperature of a burning. Therefore, it is expected that a component in which the flame-retardant resin composition of the present invention and another material are combined has a reduced possibility of breaking in a fire.

Owing to these characteristics, the flame-retardant resin composition of the present invention does not deform and exhibits self-extinguishability with a high flame retardancy even in a burning situation in a fire caught from another apparatus or component. Hence, when components are designed by combining the resin composition of the present invention and materials having a low flame retardancy under specific conditions, the components can exhibit a high flame retardancy equal to the flame retardancy of the resin composition of the present invention in a burning.

That is, interior components of electronic apparatuses are typically formed of flame-retardant resins of a UL94-V2 level. When resins of the UL94-V2 level and the resin composition of the present invention are used in combination, flame retardancy of interior components to be obtained can be improved.

### <D1/D0>

A density or specific gravity of the resin composition of the present invention is calculated using the weight of the resin composition a volume of the resin composition obtained from buoyancy in water. Density and specific gravity are different physical parameters. However, in the present invention, the density of water is adjusted to a range of from 0.999 g/cm³ through 1.000 g/cm³ in performing the measurements. Therefore, both of the density and the specific gravity become the same value when expressed by 3 significant figures. Hence, in the present invention, specific gravity is used for description.

According to the measuring method of the present invention, a flame-retardant resin that severely intumesces in a burning would give a specific gravity of less than 1. Therefore, the specific gravity of such a flame-retardant resin cannot be measured according to the method of the present invention. However, such a resin cannot achieve the object of the present invention. A resin of which specific gravity before burned is less than 1.000 is not to be included in the present invention because such a resin does not exhibit preferable mechanical properties.

In order to achieve the object of the present invention, first of all, the resin needs to sink in water in volume measurements before and after a burning test. Resins that sink in water before and after a burning test are preferable. Among such resins, flame-retardant resins that give a specific D1/D0 ratio are more preferable, where D0 is a specific gravity of the resin before a burning test and D1 is a specific gravity of the resin after the burning test.

A value (D1/D0) of 0.85 or less is not preferable because not only samples for the burning test but also molded bodies used in products deform severely in a burning. A value (D1/D0) of 0.9 or greater is preferable because samples for the burning test do not deform severely.

Weight in the present invention is measured using a balance in a manner to obtain 3 or more significant figures. Values including 3 significant figures are values obtained by rounding off the 4th digit.

A volume of a resin is measured in water that is taken out in an amount needed for the measurement from less than 1,000 cc of water having been left to stand in an atmosphere of 1 degree C. or higher but lower than 15 degrees C. for 24 hours or longer. Buoyancy applied to the resin sample when the resin sample is entirely sunk into this water in an atmosphere of 1 degree C. or higher but lower than 15 degrees C. is measured in the unit of g. This value is divided by 1.000 g/cm³, and the result is the volume V of the resin.

A weight of the resin previously measured is divided by the volume V to calculate a specific gravity D.

Such a specific gravity D0 of a sample before burned is previously calculated, and a specific gravity D1 of the sample after burned is also calculated in the same manner. Then, D1/D0 is calculated. In a preferable embodiment of the present invention, this value (D1/D0) is greater than 0.85.

The object of the present invention can be achieved even when the specific gravity of the resin has increased as a result of burning and the value (D1/D0) has changed to 1.1 or greater. Note, however, that when this value is 1.1 or greater, carbon having a high density has been produced in abundance as a result of burning to make the resin brittle. Therefore, in a more preferable embodiment, the value (D1/D0) is L1 or less.

In calculating the specific gravity after burned, it is preferable to calculate the specific gravity of a sample cut out from the burning surface to have a width of 1 cm, because this makes it possible to calculate the specific gravity of a burned portion with a good precision. It is more preferable to cut out the sample to have a width of 0.5 cm, because this provides a greater precision. It is not preferable to cut out the sample to have a width of less than 0.5 cm, because the sample for volume calculation is too small and this reduces the precision of the measurement. The preferable width by which the sample is cut out is 0.5 cm or greater but 1 cm or less.

The burning surface based on which the cut-out width is determined is one of surfaces parallel with the surface that contacted the flame perpendicularly before burning. To determine the cut-out width, this surface is assumed with respect to the surface that has formed by self-extinction after burning.

It is not preferable to leave the water to stand at a temperature of higher than 15 degrees C., because the volume would include a greater error. It is also not preferable to leave the water to stand at a temperature of lower than 0 degree C., because the water becomes ice-covered at 0 degree C. or lower and may not be able to be used for the measurement after left to stand.

It is preferable to measure the buoyancy at a temperature equal to the temperature in the atmosphere in which the water is left to stand. However, the temperature is not limited to this range because it is possible to measure the proper volume even at a temperature of 15 degrees C. or higher and to achieve the object of the present invention, provided that the specific gravity of the water is corrected based on the temperature. The temperature at which the water is left to stand and the temperature at which the buoyancy is measured are not the factors that constrain the present invention.

An example of a method for measuring the buoyancy will be described below. A beaker in which water is poured is placed on a balance, and a resin suspended with a string is sunk into the beaker 100 percent to measure the buoyancy. It is not preferable that the string have a diameter of 1 mm or greater, because the buoyancy would include a greater error. The buoyancy is measured using a string having a diameter of preferably less than 0.5 mm and more preferably less than 0.2 mm.

A combined use of the specific cyclic phosphazene derivative and the phosphoric acid ester in the resin composition can give D1/D0>0.85. The reason is as follows.

Among techniques for imparting flame retardancy to polymers, intumescent-based flame retarding techniques are known as techniques capable of imparting a high flame retardancy. These techniques are for forming intumescent carbon layers in burning surfaces. Recent techniques that have passed standards equal to or higher than UL94-V0 employ intumescent-based techniques. Specifically, the specific gravity of a burned surface after self-extinction has become lower than the density before burning because an intumescent char layer has been formed. This is how the existing methods work.

For example, the phosphoric acid ester easily intumesces in the resin composition because the phosphoric acid ester is volatile, and tends to reduce the specific gravity of the burned surface. For example, when a carbon portion is cut out from a burned sample of a flame-retardant resin composition containing a phosphoric acid ester alone as a flame retardant, the carbon portion floats in water (i.e., the specific gravity of the carbon portion is less than 1).

On the other hand, when the phosphazene derivative is used in combination as in the resin composition of the present invention, at least 50 percent or more of the phosphazene derivative remains in the carbon layer because the phosphazene derivative does not volatilize in a burning. A pyrolysate of the phosphazene derivative has a specific gravity of around 2. When a pyrolysate of the phosphazene derivative remains in the carbon layer, the carbon layer in the burned surface tends to sink into water even if the carbon layer has intumesced to some extent (i.e., the specific gravity of the carbon layer is greater than 1).

Hence, D1/D0 of flame-retardant resin compositions according to the existing techniques is 0.85 or less because the specific gravity after burned is smaller, whereas D1/D0 of the resin composition of the present invention is greater than 0.85.

### <Phosphazene Derivative>

When flame retardancy is imparted to PC using the phosphazene derivative used in the present invention in an amount of 14 percent by mass, the PC exhibits self-extinguish ability without intumescence, and the specific gravity of the PC after burned has increased slightly. Use of the phosphazene derivative alone can achieve flame retardancy, but a content of the phosphazene derivative of 14 percent by mass is not preferable because this degrades mechanical properties of the resin. What is behind this degradation of mechanical properties is assumed to be dispersion of the phosphazene derivative in the resin in the form of aggregates, judging from that there is a considerable degradation in impact strength.

Based on this assumption, the content rate of the phosphazene derivative is preferably less than 10 percent by mass and more preferably less than 3.0 percent by mass.

That is, it is preferable that the content rate of the phosphazene derivative in the resin composition be 0.1 percent by mass or greater but less than 3.0 percent by mass.

When intumescence is suppressed, deformation of a resin is also suppressed. Such a resin does not spoil a flame retardancy performance of a component produced by combining the resin with another flame-retardant resin. The resin composition of the present invention is referred to as flame-retardant resin A, and a flame-retardant resin to be combined is referred to as flame-retardant resin B. Here, the flame-retardant resin A is assumed to have a flame retardancy level to pass UL94-V0 or higher, whereas the flame-retardant resin B is assumed to have a UL94-V2 level. Even in this case, if the flame-retardant resin A is disposed less than 3 centimeters below the flame-retardant resin B, the flame-retardant resin A can receive a melt of the flame-retardant resin B and prevent surrounding things from catching fire.

The flame-retardant resin A and the flame-retardant resin B may be made to contact each other to have a gap of 0 in assembling a component. That is, it is preferable that the flame-retardant resin B be located below the flame-retardant resin A at a position that is 0.0001 centimeters or more away from the flame-retardant resin A. The upper limit is not particularly limited, but is preferably less than 3 centimeters below the flame-retardant resin A because this makes it possible to receive a melt from the flame-retardant resin A.

Here, it is not preferable to produce a component using the flame-retardant resin constituting the flame-retardant resin B instead of the flame-retardant resin A, because a melt from the flame-retardant resin B would spread a fire.

The flame-retardant resin B may be located at a position contacting the flame-retardant resin A.

The flame-retardant resin B is formed of a flame-retardant resin that passes UL94-V2 by producing a melt in the test to cause an endothermic effect based on the melting phenomenon. The flame-retardant resin B has a limiting oxygen index (LOI) of preferably 1.8 or greater and more preferably 19 or greater.

A LOI of the flame-retardant resin A of the present invention has no particular upper limit, but a LOI of 28 or greater is not preferable, because the flame-retardant resin A is a resin that does not produce a melt in a burning and this entails a need for a large amount of a flame retardant to realize this LOI, leading to degradation of mechanical properties.

The flame retardant used in the flame-retardant resin B may be, for example, the flame retardant described in Nishizawa, Hitoshi. (supervisor) Flame Retardant Technology of Polymeric Materials, CMC Publishing Co., Ltd., 2002. The present invention is not particularly limited in this matter. In light of the object of the present invention, it is only needed that the flame-retardant resin B be a flame-retardant resin that has passed a burning test of a UL94-V2 level or higher even as a result of producing a melt.

The phosphazene derivative is preferably a phosphazene derivative represented by general formula (1) below in terms of ease of production and stability of the compound.

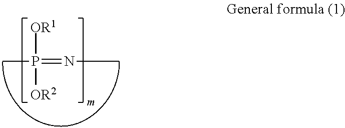

In general formula (1), R¹ and R² independently represent an aromatic ring-containing group free of a halogen atom, and m represents any of 3 through 8.

Cyclic compounds in which m is 9 or greater are known to exist. However, m is preferably 8 or less because this makes it easier for the phosphazene derivative to dissolve in the phosphoric acid ester used in combination in the present invention.

Depending on the producing method, the phosphazene derivative may be produced as a mixture of cyclic compounds varied in m. Here, it is preferable that a cyclic compound in which m is 3 account for 50 percent by mass or greater and preferably 70 percent by mass or greater in the phosphazene derivative, because this makes it easier for the phosphazene derivative to melt at a temperature in kneading.

It is also preferable that a derivative in which in is 3 account for 100 percent by mass, because this does not make the melting point of the phosphazene derivative higher than 150 degrees C.

The melting point of the phosphazene derivative represented by general formula (1) is not particularly limited and may be appropriately selected depending on the intended purpose. However, the melting point of the phosphazene derivative is preferably 70 degrees C. or higher.

The side-chain groups R¹ and R² in general formula (1) are formed by allowing an alcoholic hydroxyl group-containing compound such as cyclohexanol, cyclohexane methanol, menthol, phenylmethanol, quinolinol, and phenol or an amino group-containing compound such as aniline to undergo a reaction with a cyclic phosphazene having halogen in a side chain.

The compound to form the side chain groups may be anything such as an aliphatic compound and an aromatic compound. However, an aromatic ring-containing compound is preferable for stability of the phosphazene derivative and solubility to the phosphoric acid ester. It is not preferable that any one of R¹ and R² be a halogen atom, because stability of the phosphazene would degrade as known.

Among these examples, phenyl groups are preferable as RI and R².

In order to obtain the phosphazene derivative represented by general formula (1), it is not preferable to use an aromatic compound containing 2 or more functional groups reactive with halogenated phosphazene, because ring structures would be linked to increase the molecular weight or form a three-dimensional structure to become less soluble in the phosphoric acid ester. For the object of the present invention, a structure in which 2 or more phosphazene rings are linked or 3 or more phosphazene rings are crosslinked is not preferable.

Hence, as compounds that can function to chemically modify halogenated phosphazene, aromatic ring-containing compounds containing only 1 functional group are optimum as the side-chain groups of the phosphazene derivative used in the present invention.

However, multifunctional compounds may be used for the phosphazene derivative unless 2 or more cyclic phosphazene derivatives are linked depending on reaction conditions in the synthesis.

A content of the phosphazene derivative in the resin composition is 0.1 percent by mass or greater but less than 3.0 percent by mass.

When the content rate of the phosphazene derivative is less than 0.1 percent by mass, the object of the present invention may not be achieved because the content of the phosphazene derivative is low. A content rate of the phosphazene derivative of 3.0 percent by mass or greater is not preferable, because the phosphazene derivative is more likely to aggregate in the flame-retardant resin during kneading. When the content rate of the phosphazene derivative is less than 3.0 percent by mass, the abundance ratio of the phosphazene derivative in the flame-retardant resin is low. This makes the phosphazene derivative less likely to aggregate and makes it easier to achieve the object of the present invention.

### <Phosphoric Acid Esters>

The phosphoric acid ester used in combination in the present invention is used in combination in order to prevent aggregation of the phosphazene derivative described above.

Hence, in producing the resin composition, it is preferable that the phosphoric acid ester melt at a kneading temperature. That is, the phosphoric acid ester is a compound having a melting point (Tm), and Tm of the phosphoric acid ester is preferably lower than 300 degrees C., more preferably lower than 200 degrees C., and particularly preferably lower than 100 degrees C. The most preferable lower limit of Tm of the phosphoric acid ester is 0 degree C. or higher, but the lower limit of Tm of the phosphoric acid ester is not limited in the present invention so long as the phosphoric acid ester becomes a molten state during kneading. However, Tm of the phosphoric acid ester of lower than minus 40 degrees C. is not preferable because a phenomenon called bleed-out would be severe. Bleed-out is a phenomenon in which the phosphoric acid ester, when dispersed in a resin, floats up to the surface along with time.

Among phosphoric acid esters, there are compounds that form a three-dimensional structure, do not melt during kneading, and have no Tm. These compounds are not preferable in the present invention.

The melting point of the phosphoric acid ester is preferably lower than the melting point of the phosphazene derivative represented by general formula (1).

Examples of the phosphoric acid ester are presented below. Note that the present invention is not particularly limited to these examples.

Examples of the phosphoric acid ester include: one of, or mixtures of 2 or more of, tri(alkylphenyl)phosphate, di(alkylphenyl)monophenyl phosphate, diphenyl mono(alkylphenyl)phosphate, and triphenyl phosphate: and one of, or mixtures of 2 or more of, compounds represented by general formula (2) below.

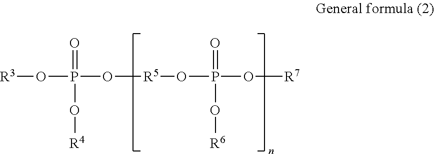

In general formula (2), R³ to R⁷ independently represent an aromatic ring-containing group, and n represents any of 1 through 10,000.

R³ to R⁷ are each aryl, or an alkyl-substituted aryl group. Preferably, R³, R⁴, R⁶, and R⁷ are each a phenyl group or a phenyl group in which an alkyl group such as methyl, ethyl, isopropyl, t-butyl, isobutyl, isoamyl, and t-amyl is substituted. Among these examples, a phenyl group or a phenyl group in which methyl, ethyl, isopropyl, or a t-butyl group is substituted is more preferable. R⁵ is aryl or an alkyl-substituted aryl group derivative, and preferably a derivative of resorcinol, hydroquinone, or bisphenol-A.

The phosphoric acid ester is used in order to disperse the phosphazene derivative in a resin matrix. There is a need that a content of the phosphoric acid ester totaled with the phosphazene derivative not be greater than 14 percent by mass. When the total is 14 percent by mass or greater, there is a less effect of using the phosphoric acid ester in combination with the phosphazene derivative. This makes the resin likely to intumesce in a burning.

When the total content of the phosphoric acid ester and the phosphazene derivative is less than 5 percent by mass, a sufficient flame retardancy may not be obtained. The total content of the phosphorus-containing compound is preferably 8 percent by mass or greater.

The object of the present invention can be achieved even when the phosphorus-containing compound used in the present invention is used in combination with a compound containing phosphorus described in Nishizawa, Hitoshi. (supervisor) Flame Retardant Technology of Polymeric Materials, CMC Publishing Co., Ltd., 2002, such as a phosphoric acid ester based flame retardant represented by red phosphorus, so long as the content of the phosphazene derivative is 1 percent by mass or greater but less than 3 percent by mass.

It is preferable to previously disperse the phosphorus-containing compound in a polymer A other than PC before use, because this makes the flame-retardant resin of the present invention to be produced less likely to thermally deform at a high temperature.

Here, a method of dispersing materials other than the phosphazene derivative in the polymer A first and then kneading these materials with the phosphazene derivative and PC is preferable.

So long as the object of the present invention can be achieved, whether to produce the composition by one time of kneading or to knead the materials in different combinations is not limited.

However, considering mechanical properties, it is preferable that the total amount of the phosphorus-containing compound be less than 14. percent by mass in the resin composition.

It is not preferable that the total amount of the phosphorus-containing compound be 14 percent by mass or greater, because impact strength would be degraded.

When the total amount of the phosphorus-containing compound is less than 1 percent by mass, a sufficient flame retardancy may not be obtained and the object of the present invention may not he achieved. Hence, the content rate of the phosphorus-containing compound in the resin composition is preferably 5 percent by mass or greater and more preferably 8 percent by mass or greater, because a high flame retardancy can be obtained, and a time taken to come to self-extinction in a burning due to a caught fire can be shortened.

Flame retardancy can be achieved even when the phosphazene derivative alone is used as the phosphorus-containing compound used in the present invention. However, addition of the phosphazene derivative in an amount of 14 percent by mass or greater is not preferable because this considerably degrades impact strength.

### <Red Phosphorus>

Red phosphorus as a flame retardant to be combined with the phosphazene derivative is preferable because red phosphorus has a high phosphorus content and can provide a high flame retard effect when used in combination in an amount of 1 percent by mass or greater. However, use of red phosphorus in an amount of 13 percent by mass or greater is not preferable because this considerably degrades impact strength. Addition of red phosphorus in an amount of preferably 8 percent by mass or less can suppress degradation of impact strength.

Red phosphorus may be added while the flame-retardant resin composition of the present invention is kneaded. However, it is preferable to previously knead red phosphorus with a polymer other than PC and then add the obtained composition to the flame-retardant resin composition while the flame-retardant resin composition is kneaded.

### <PC (Polycarbonate)>

The PC (polycarbonate) used in the present invention is not particularly limited, and may be a homopolymer formed of a structural unit represented by general formula (3) below or a copolymer containing the structural unit represented by general formula (3).

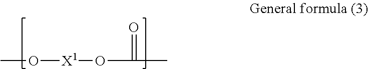

In general formula (3), X¹ represents a divalent hydrocarbon group.

In general formula (3), the divalent hydrocarbon group is, for example, an alkylene group or an arylene group, and is particularly preferably —PhC(CH₃)₂Ph—. In terms of imparting various properties to the resin composition, the divalent hydrocarbon group may be an alkylene group or an arylene group into which a heteroatom is incorporated. Here, Ph represents a phenylene group.

The polycarbonate may be straight-chained or branched. In the case of a copolymer, a copolymerization form may be selected from various copolymerization forms such as random copolymerization and block copolymerization. Typically, such polycarbonate copolymers are thermoplastic resins.

Polycarbonates are classified into aromatic polycarbonate resins in which carbon directly binding with a carbonate bond (—COO—) is aromatic carbon and aliphatic polycarbonate resins in which such carbon is aliphatic carbon. Any of these polycarbonate resins may be preferably used. In terms of improving heat resistance, mechanical properties, electrical properties, etc. of the resin composition, aromatic polycarbonate resins are preferable.

One of these polycarbonates may be used alone or two or more of these polycarbonates may be used in combination at an arbitrary ratio.

Specific examples of the polycarbonate include, but are not particularly limited to: reaction products obtained by allowing a dihydroxy compound, a carbonate precursor, and optionally, a polyhydroxy compound or the like to undergo a reaction; and reaction products obtained by allowing a cyclic ether and a carbonate precursor (particularly, carbon dioxide) to undergo a reaction.

Specific examples of aromatic dihydroxy compounds among dihydroxy compounds as a material of the polycarbonate include: dihydroxybenezenes such as 1,2-dihydroxybenzene, 1,3-dihydroxybenzene (i.e., resorcinol), and 1,4-dihydroxybenzene; dihydroxybiphenyls such as 2,5-dihydroxybiphenyl, 2,2′-dihydroxybiphenyl, and 4,4′-dihydroxybiphenyl; dihydroxynaphthalenes such as 2,2′-dihydroxy-1,1′-binaphthyl, 1,2-dihydroxynaphthalene, 1,3-dihydroxynaphthalene, 2,3-dihydroxynaphthalene, 1,6-dihydroxynaphthalene, 2,6-dihydroxynaphthalene, 1,7-dihydroxynaphthalene, and 2,7-dihydroxynaphthalene; dihydroxydiaryl ethers such as 2,2′-dihydroxydiphenyl ether, 3,3′-dihydroxydiphenyl ether, 4,4′-dihydroxydiphenyl ether, 4,4′-dihydroxy-3,3′-dimethyldiphenyl ether, 1,4-bis(3-hydroxyphenoxy)benzene, and 1,3-bis(4-hydroxyphenoxy)benzene; bis(hydroxyaryl)alkanes such as 2,2-bis(4-hydroxyphenyl)propane (i.e., bisphenol A), 1,1-bis(4-hvdroxyphenyl)propane, 2,2-bis(3-methyl-4-hydroxyphenyl)propane, 2,2-bis(3-methoxy-4-hydroxyphenyl)propane, 2-(4-hydroxyphenyl)-2-(3methoxy-4-hydroxyphenyl)propane, 1,1-bis(3-tert-butyl-4-hydroxyphenyl)propane, 2,2-bis(4-hydroxy-3,5-dimethylphenyl)propane, 2,2-bis(3-cyclohexyl-4-hydroxyphenyl)propane, 2-(4-hydroxyphenyl)-2-(3-cyclohexyl-4-hydroxyphenyl)propane, α,α′-bis(4-hydroxyphenyl)-1,4-diisopropylbenzene, 1,3-bis[2-(4-hydroxyphenyl)-2-propyl]benzene, bis(4-hydroxyphenyl)methane, bis(4-hydroxyphenyl)cyclohexylmethane, bis(4-hydroxyphenyl)phenylmethane, bis(4-hydroxyphenyl) (4-propenylphenyl)methane, bis(4-hydroxyphenyl)diphenylmethane, bis(4-hydroxyphenyl)naphthylmethane, 1-bis(4-hydroxyphenyl)ethane, 2-bis(4-hydroxyphenyl)ethane, 1,1-bis(4-hydroxyphenyl)-1-phenylethane, 1,1-bis(4-hydroxyphenyl)-1-naphthylethane, 1-bis(4-hydroxyphenyl)butane, 2-bis(4-hydroxyphenyl)butane, 2,2-bis(4-hydroxyphenyl) pentane, 1,1-bis(4-hydroxyphenlyl)hexane, 2,2-bis(4-hydroxyphenyl)hexane, 1-bis(4-hydroxyphenyl)octane, 2-bis(4-hydroxyphenyl)octane, 1-bis(4-hydroxyphenyl)hexane, 2-bis(4-hydroxyphenyl)hexane, 4,4-bis(4-hydroxyphenyl)heptane, 2,2-bis(4-hydroxyphenyl)nonane, 10-bis(4-hydroxyphenyl)decane, and 1-bis(4-hydroxyphenyl)dodecane; bis(hydroxyaryl)cycloalkanes such as 1-bis(4-hydroxyphenyl)cyclopentane, 1-bis(4-hydroxyphenyl)cyclohexane, 4-bis(4-hydroxyphenyl)cyclohexane, 1,1-bis(4-hydroxyphenyl)-3,3-dimethylcyclohexane, 1-bis(4-hydroxyphenyl)-3,4-dimethylcyclohexane, 1,1-bis(4-hydroxyphenyl)-3,5-dimethylcyclohexane, 1,1-bis(4-hydroxyphenyl)-3,3,5-trimethylcyclohexane, 1,1-bis(4-hydroxy-3,5-dimethylphenyl)-3,3,5-trimethylcyclohexane, 1,1-bis(4-hydroxyphenyl)-3-propyl-5-methylcyclohexane, 1,1-bis(4-hydroxyphenyl)-3-tert-butyl-cyclohexane, 1,1-bis(4-hydroxyphenyl)-3-phenylcyclohexane, and 1,1-bis(4-hydroxyphenyl)-4-phenylcyclohexane; cardo structure-containing bisphenols such as 9,9-bis(4-hydroxyphenyl)fluorene and 9,9-bis(4-hydroxy-3-methylphenyl)fluorene; dihydroxydiarylsulfides such as 4,4′-dihydroxydiphenylsulfide and 4,4′-dihydroxy-3,3′-dimethyldiphenylsulfide; dihydroxydiarylsulfoxides such as 4,4′-dihydroxydiphenylsulfoxide and 4,4′-dihydroxy-3,3′-dimethyldiphenylsulfoxide; and dihydroxydiarylsulfones such as 4,4′-dihydroxydiphenylsulfone and 4,4′-dihydroxy-3,3′-dimethyldiphenylsulfone.

Among these aromatic dihydroxy compounds, bis(hydroxyaryl)alkanes are preferable. Among bis(hydroxyaryl)alkanes, bis(4-hydroxyphenyl)alkanes are preferable. In terms of impact resistance and heat resistance, 2,2-bis(4-hydroxyphenyl)propane bisphenol. A) is particularly preferable.

One of these aromatic dihydroxy compounds may be used alone or two or more of these aromatic dihydroxy compounds may be used in combination at an arbitrary ratio.

Specific examples of aliphatic dihydroxy compounds among dihydroxy compounds as a material of the polycarbonate include: alkanediols such as ethane-1,2-diol, propane-1,2-diol, propane-1,3-diol, 2,2-dimethylpropane-1,3-diol, 2-methyl-2-propylpropane-1,3-diol, butane-1,4-diol, pentane-1,5-diol, hexane-1,6-diol, and decane-1,10-diol; cycloalkanediols such as cyclopentane-1,2-diol, cyclohexane-1,2-diol, cyclohexane-1,4-diol, 1, 4-cyclohexanedimethanol, 4-(2-hydroxyethyl)cyclohexanol, and 2,2,4,4-tetramethyl-cyclobutane-1,3-diol; glycols such as 2,2′-oxydiethanol (i.e., ethylene glycol), diethylene glycol, triethylene glycol, propylene glycol, spiroglycol; and aralkyldiols such as 1,2-benzenedimethanol, 1,3-benzenedimethanol, 1,4-benzenedimethanol, 1,4-benzenediethanol, 1,3-bis(2-hydroxyethoxy)benzene, 1,4-bis(2-hydroxyethoxy)benzene, 2,3-bis(hydroxymethyl)naphthalene, 1,6-bis(hydroxyethoxy)naphthalene, 4,4′-biphenyldimethanol, 4,4′-biphenyldiethanol, 1,4-bis(2-hydroxyethoxy)biphenyl, bisphenol. A bis(2-hydroxyethyl)ether, and bisphenol S bis(2-hydroxyethyl)ether.

One of these aliphatic dihydroxy compounds may be used alone or two or more of these aliphatic dihydroxy compounds may be used in combination at an arbitrary ratio.

Specific examples of cyclic ethers as a material of the polycarbonate include 1,2-epoxyethane (i.e., ethylene oxide), 1,2-epoxypropane (i.e., propylene oxide), 1,2-epoxycyclopentane, 1,2-epoxycyclohexane, 1,4-epoxycyclohexane, 1-methyl-1,2-epoxycyclohexane, 2,3-epoxynorbornane, and 1,3-epoxypropane.

One of these cyclic ethers may be used alone or two or more of these cyclic ethers may be used in combination at an arbitrary ratio.

Specific examples of carbonate precursors as a material of the polycarbonate include carbonyl halides, carbonate esters, and carbon dioxide.

Specific examples of the carbonyl halides include: phosgene; and haloformates such as bischloroforinate form of dihydroxy compounds and monochloroformate form of dihydroxy compounds. Specific examples of the carbonate esters include: diaryl carbonates such as diphenyl is carbonate and ditolyl carbonate; diallyl carbonates such as dimethyl carbonate and diethyl carbonate; and carbonate form of dihydroxy compounds such as biscarbonate form of dihydroxy compounds, monocarbonate form of dihydroxy compounds, and cyclic carbonates.

One of these carbonate precursors may be used alone or two or more of these carbonate precursors may be used in combination at an arbitrary ratio.

A method for producing the polycarbonate used in the present invention is not particularly limited, and an arbitrary method may be used. Examples of the method include interfacial polymerization methods, melt transesterification methods, pyridine methods, methods for ring-opening polymerization of cyclic carbonate compounds, methods for solid-phase transesterification of prepolymers.

A molecular weight of the polycarbonate may be appropriately determined as needed.

Particularly, a viscosity average molecular weight (Mv) of the polycarbonate calculated based on conversion of solution viscosity may be typically 10,000 or greater and is preferably 16,000 or greater and more preferably 17,000 or greater in terms of imparting a greater mechanical strength to the resin composition, and may be typically 40,000 or less and is preferably 30,000 or less and more preferably 24,000 or less in terms of suppressing degradation of flowability of the resin composition to improve moldability of the resin composition and make a molding process smooth.

Viscosity average molecular weight [Mv] refers to a value obtained by measuring a limiting viscosity (η) (unit: dl/g) with an Ubbelohde viscometer at a temperature of 20 degrees C. using methylene chloride as a solvent and calculating a Schnell's viscosity formula, i.e., η=1.23×10⁻⁴ Mv^{0.83}. Limiting viscosity (η) is a value obtained by measuring a specific viscosity [ηsp] at various solution concentrations [C] (g/dl) and calculating a formula below.

$$η = {lim}_{c -> 0} {η}_{sp} / c$$

Two or more polycarbonate resins having different viscosity average molecular weights (Mv) may be used as a mixture. In this case, a polycarbonate resin having a viscosity average molecular weight outside the preferable range described above may be mixed.

A terminal hydroxyl concentration of the polycarbonate may be appropriately determined as needed, may be typically 10 ppm or greater and is preferably 30 ppm or greater and more preferably 40 ppm or greater in terms of suppressing decrease of the molecular weight and improving mechanical properties of the resin composition, and may be typically 1,000 ppm or less and is preferably 800 ppm or less and more preferably 600 ppm or less in terms of imparting a greater residence heat stability and a greater color tone to the resin composition.

The unit of the terminal hydroxyl concentration is a weight of terminal hydroxyl to a weight of the polycarbonate in ppm. The terminal hydroxyl concentration may be measured by, for example, colorimetry by a titanium tetrachloride/acetic acid method (see, e.g., Macromol. Chem. 88 215, 1965).

The polycarbonate may include a polycarbonate oligomer in terms of improving appearance of a molded product and improving flowability. A viscosity average molecular weight [Mv] of the polycarbonate oligomer is typically 1,500 or greater and preferably 2,000 or greater, and typically 9,500 or less and preferably 9,000 or less. It is preferable that a content of the polycarbonate oligomer be 30 parts by mass or less relative to 100 parts by mass of the polycarbonate (including the polycarbonate oligomer).

In the present invention, it is preferable that the content rate of the polycarbonate in the resin composition be 50 percent by mass or greater but less than 95 percent by mass. The reason is as follows.

It is preferable that the content rate of the polycarbonate be less than 95 percent by mass because the flame retardant can be sufficiently included in the resin composition and a sufficient flame retardancy can be obtained. On the other hand, it is preferable that the content rate of the polycarbonate be 50 percent by mass or greater because a sufficient flame retardancy can be obtained when the phosphorous-containing compound is used at the content rate specified in the present invention.

When the polycarbonate accounts for 80 percent by mass or greater of the total amount of the flame-retardant resin composition, the flame-retardant resin composition has a poor flowability during injection molding when the flame-retardant resin composition is combined with another polymer. This may distort the molded body obtained, and the molded body is likely to deform in a burning. Hence, the ratio of the PC in the flame-retardant resin composition is preferably less than 80 percent by mass.

A heat deformation temperature varies depending on the polymer A to be combined. Hence, considering moldability and deformation at a high temperature, a more preferable range of the ratio of the polycarbonate is 60 percent by mass or greater but less than 80 percent by mass of the total amount of the flame-retardant resin composition.

### <Polymer A>

The polymer A is a resin other than PC.

As the polymer A to be added in the resin composition, any resin component may be contained as a resin component of the resin composition. However, a modified PC compatible with PC is not preferable because such a modified PC would lower the heat deformation temperature due to a plasticizing effect.

Polymers incompatible with PC or partially compatible with PC are preferable in terms of deformation at a high temperature and mechanical properties.

Examples of resins other than PC include: thermoplastic polyester resins such as modified products of naturally occurring polymers such as polysaccharides (e.g., cellulose and paramylon), polylactic acid-based resins, other naturally occurring polymers, ABS, polystyrenes (PS), polyethylene terephthalate resins, polytrimethylene terephthalate, and polybutylene terephthalate resins; polyolefin resins such as polyethylene resins (PE) and polypropylene resins (PP); polyamide resins (PA) such as nylon 6 and nylon 66; polyimide resins: polyether imide resins; polyurethane resins, polyphenylene ether resins, polyphenylene sulfide resins; polysulfone resins; polymethacrylate resins; and known resin additives.

One of these other resins may be used alone or two or more of these other resins may be used in combination at an arbitrary ratio.

Examples of preferable resin components include polyolefins, PA, PS, polyesters such as PET, PEN, and PBT, ABS, modified products of naturally occurring polymers such as polysaccharides (e.g., cellulose and paramylon), polylactic acid-based resins, and other naturally occurring polymers.

Polymers used as polyolefins, nylon (PA), polystyrenes (PS), and polyesters are polymers described op. cit., Ooyanagi, Yasushi. (editor) Practice ofPol merAlloy, Agne Shofu Publishing Inc., 1993, and Akiyaina, Sahuro. Essential Polymer Alloy, CMG Publishing Co., Ltd., 2012.

Examples of modified polymers obtained from polysaccharides extracted from naturally occurring products include: cellulose-based resins described in Marusawa, Hiroshi. and Kazuo Uda Cellulose Resins, Nikkan Kogyo Shimbun, Ltd., 1978, such as TAC and DAC, which are modified products of cellulose; and derivatives obtained by modifying a hydroxyl group of β-1,3-glucan called paramylon extracted from euglena, e.g., a β-1,3-glucan derivative described in Japanese Unexamined. Patent Application Publication No. 2014-98095.

PS, ABS, polyesters, and modified resin products of polymers extracted from naturally occurring products are particularly preferable. ABS resins are preferable because ABS resins can improve mechanical properties of resins. Considering ecological trends of late, recycled PET resins and modified resin products of polymers extracted from naturally occurring products are preferable because these resins can reduce environmental impacts.

Such a resin other than PC is contained in the resin composition in an amount of 10 percent by mass or greater but less than 50 percent by mass. When the content rate of such a resin is 50 percent by mass or greater, flame retardancy of the resin may be degraded. When the content rate of such a resin is less than 10 percent by mass, mechanical properties may be degraded.

A more preferable content rate of such a resin is 20 percent by mass or greater but less than 40 percent by mass.

In the present invention, heat deformation at a high temperature is improved when the phosphorus-containing compound is dispersed in the polymer A. In order to obtain a high-order structure in which the phosphorus-containing compound is dispersed in the polymer A dispersed in the polycarbonate, a process of previously kneading the polymer A with the phosphorus-containing compound and adding the kneaded product to the polycarbonate is selected.

In this process, it is needed that the polymer A be added in the resin composition in an amount of 20 percent by mass or greater, preferably 25 percent by mass or greater, and more preferably 30 percent by mass or greater.

Note that the composition may be produced by one time of kneading so long as the object of the present invention can be achieved.

### <Fluororesin>

In order to prevent the resin that melts in a burning from dripping, it is preferable to add a fluororesin in the resin composition. Among fluororesins, fibrillated fluororesins developed for prevention of melting are preferable.

Fibrillated fluororesins used in the present invention are not particularly limited. For example, resins obtained by fibrillating polytetrafluoroethylene to have a fibrous network structure are used. Acrylic-modified polytetrafluoroethylene is preferable because acrylic-modified polytetrafluoroethylene has a large effect of compatibilization with the resin.

Preferable commercially available products are METHABRENE A-3000, METHABRENE A-3700, and METHABRENE A-3800 (name of products available from Mitsubishi Rayon Co., Ltd.). One of these fibrillated fluororesins may be used alone or two or more of these fibrillated fluororesins may be used in combination. A content rate of the fibrillated fluororesin (C) in the resin composition is preferably 0 percent by mass or greater but 0.5 percent by mass or less and more preferably 0.1 percent by mass or greater but 0.35 percent by mass or less. In this range, dispersion of the additive is favorable. It is not preferable to add the fibrillated fluororesin in an amount of greater than 0.5 percent by mass, because density reduction may occur upon intumescence caused by a fluoride produced from thermal decomposition.

### <Compatibilizer>

Because two or more resins are kneaded to produce the flame-retardant resin composition of the present invention, a known compatibilizer may be used to improve mechanical properties. Additives sold as compatibilizers, METHABRENE L-TYPE available from Mitsubishi Rayon Co., Ltd. are suitable for use in the present invention.

Although not being sold as compatibilizers, copolymers synthesized by polymerization of 2 or more monomers, such as a styrene-acrylonitrile-glycidyl methacrylate terpolymer, may also be used as compatibilizers in the present invention.

An amount, to be added, of a compatibilizer or a copolymer synthesized from 2 or more monomers is preferably from 0.2 percent by mass through 5 percent by mass of the resin composition.

In the present invention, addition of a compatibilizer or a copolymer in an amount of 5 percent by mass or greater in order to improve compatibilization of the resin is not preferable because a drip phenomenon may occur in a burning. A more preferable amount of a compatibilizer or a copolymer to be added is less than 3 percent by mass. When the amount of a compatibilizer or a copolymer to be added is less than 0.2 percent by mass, there is no effect of adding a compatibilizer or a copolymer, and mechanical properties may not be improved. Therefore, when to be added, a compatibilizer or a copolymer needs to be added in an amount of 0.2 percent by mass or greater, preferably 0.5 percent by mass or greater, and more preferably 1 percent by mass or greater.

### <Other Additives>

The flame-retardant resin composition according to an embodiment of the present invention may include a phosphorus-based stabilizer, a phenol-based stabilizer, a lubricant, any other resin (a resin other than polycarbonate and styrene-based polymers), an ultraviolet absorber, a dye or pigment, an antifogging agent, an anti-blocking agent, a flowability improving agent, a plasticizer, a dispersant, an antibacterial agent, and other additives so long as flame retardancy, stiffness, impact resistance, and other properties are not considerably degraded.

### —Phosphorus-Based Stabilizer—

It is preferable that the flame-retardant resin composition according to an embodiment include a phosphorus-based stabilizer as needed. Known phosphorus-based stabilizers may be used. Specific examples of known phosphorus-based stabilizers include: oxoacids of phosphorus, such as phosphoric acid, phosphoric acid, phosphorous acid, phosphinic acid, and polyphosphoric acid; metal salts of acidic pyrophosphoric acid, such as sodium acid pyrophosphate, potassium acid pyrophosphate, and calcium acid pyrophosphate; phosphates of Group-1 or Group-2B metals, such as potassium phosphate, sodium phosphate, cesium phosphate, and zinc phosphate; organic phosphate compounds; organic phosphonite compounds; and organic phosphite compounds. Organic phosphite compounds are particularly preferable.

Examples of the organic phosphite compounds include triphenyl phosphite, tris(monononylphenyl)phosphite, tris(monononyl/dinonyl phenyflphosphite, tris(2,4-di-tert-butylphenyl)phosphite, monooctyldiphenyl phosphite, dioctylmonophenyl phosphite, monodecyldiphenyl phosphite, didecylmonophenyl phosphite, tridecyl phosphite, trilauryl phosphite, trisstearyl phosphite, and 2,2-methylene bis(4,6-di-tert-butylphenyl)octyl phosphite.

Examples of commercially available products of organic phosphite compounds include; “ADEKASTAB 1178”, “ADEKASTAB 2112”, and “ADEKASTAB HP-10” available from Adeka Corporation; “JP-351”, “JP-360”, and “JP-3CP” available from Johoku Chemical Co., Ltd., and “IRGAFOS 168” available from Ciba Specialty Chemicals Inc.

One of these phosphorus-based stabilizers may be used alone or two or more of these phosphorus-based stabilizers may be used in combination at an arbitrary ratio.

A content of the phosphorus-based stabilizer is typically 0.001 parts by mass or greater, preferably 0.01 parts by mass or greater, and more preferably 0.02 parts by mas or greater relative to a total. of 100 parts by mass of the resin composition in terms of obtaining a sufficient thermal stabilizing effect, and is typically 1 part by mass or less, preferably 0.7 parts by mass or less, and more preferably 0.5 parts by mass or less relative to a total of 100 parts by mass of the resin composition in terms of avoiding economic loss due to plateauing of the thermal stabilizing effect.

### —Phenol-Based Stabilizer—

It is also preferable that the flame-retardant resin composition according to an embodiment include a phenol-based stabilizer. Examples of the phenol-based stabilizer include hindered phenol-based antioxidants.

Specific examples of hindered phenol-based antioxidants include pentaerythritol tetrakis[3-(3,5-di-tert-butyl-4-hydroxyphenyl) propionate], octadecyl-3-(3,5-di-tert-butyl-4-hydroxphenyl)propionate, thiodiethylene bis[3-(3,5-di-tert-butyl-4-hydroxyphenyl)propionate], N,N′-hexane-1,6-diylbis[3-(3,5-di-tert-butyl-4-hydroxyphenylpropionamide), 2,4-dimethyl-6-(1-methylpentadecyl)phenol, diethyl[[3,5-bis(1,1-dimethylethyl)-4-hydroxyphenyl]methyl]phosphate, 3,3′,3″,5,5′,5″-hexa-tert-butyl-α,α′,α″-(methylene-2,4,6-triyl)tri-p-cresol, 4,6-bis(octylthiomethyl)-o-cresol, ethylene bis(oxyethylene)bis[3-(5-tert-butyl-4-hydroxy-m-tolyl)propionate], hexamethylene bis[3-(3,5-di-tert-butyl-4-hydroxyphenyl)propionate], 1,3,5-tris(3,5-di-tert-butyl-4-hydroxybenzyl)-1,3,5-triazine-2,4,6(1H,3H,5H)-trione, 2,6-di-tert-butyl-4-(4,6-bis(octylthio)-1,3,5-tirazine-2-ylamino)phenol, and 2-[1-(2-hydroxy-3,5-di-tert-pentylphenyl)ethyl]-4,6-di-tert-pentylphenyl acrylate. Pentaerythritol tetrakis[3-(3,5-di-tert-butyl-4-hydroxyphenyl)propionate]and octadecyl-3-(3,5-di-tert-butyl-4-hydroxyphenyl)propionate are particularly preferable.

Examples of commercially available products of hindered-phenol-based antioxidants include: “IRGANOX 1010” and “IRGANOX 1076” available from Ciba Specialty Chemicals Inc.; and “ADEKASTAB AO-50” and “ADEKASTAB AO-60” available from Adeka Corporation.

One of these phenol-based stabilizers may be used alone or two or more of these phenol-based stabilizers may be used in combination at an arbitrary ratio.

A content of the phenol-based stabilizer is typically 0.001 parts by mass or greater and preferably 0.01 parts by mass or greater relative to a total of 100 parts by mass of the resin composition in terms of obtaining a sufficient effect as a stabilizer, and is typically 1 part by mass or less and preferably 0.5 parts by mass or less relative to a total of 100 parts by mass of the resin composition in terms of avoiding economic loss due to plateauing of the effect as a stabilizer.

### —Lubricant—

It is preferable that the flame-retardant resin composition according to an embodiment include a lubricant as needed. Examples of the lubricant include aliphatic carboxylic acids, esters of aliphatic carboxylic acids with alcohols, aliphatic hydrocarbon compounds having a number average molecular weight of from 200 through 15,000, and polysiloxane-based silicone oils.

Examples of aliphatic carboxylic acids include saturated or unsaturated aliphatic monovalent, divalent, or trivalent carboxylic acids. Here, aliphatic carboxylic acids encompass alicyclic carboxylic acids. Among these aliphatic carboxylic acids, monovalent or divalent carboxylic acids containing from 6 through 36 carbon atoms are preferable, and aliphatic saturated monovalent carboxylic acids containing from 6 through 36 carbon atoms are more preferable.

Specific examples of aliphatic carboxylic acids include palmitic acid, stearic acid, caproic acid, capric acid, lauric acid, arachic acid, behenic acid, lignoceric acid, cerotic acid, melissic acid, tetrariacontanoic acid, montanoic acid, adipic acid, and azelaic acid.

Examples of aliphatic carboxylic acids in the esters of aliphatic carboxylic acids and alcohols include the same as the examples of the aliphatic carboxylic acid presented above.

Examples of alcohols include saturated or unsaturated monovalent or polyvalent alcohols. Particularly, monovalent or polyvalent saturated alcohols containing 30 or less carbon atoms are preferable, and aliphatic saturated monovalent alcohols containing 30 or less carbon atoms and aliphatic saturated polyvalent alcohols containing 30 or less carbon atoms are more preferable. These alcohols may include substituents such as a fluorine atom and an aryl group. Aliphatic series encompass alicyclic compounds.

Specific examples of alcohols include octanol, decanol, dodecanol, stearyl alcohol, behenyl alcohol, ethylene glycol, diethylene glycol, glycerin, pentaerythritol, 2,2-dihydroxyperfluoropropanol, neopentylene glycol, ditrimethylolpropane, and dipentaerythritol.

The esters may include aliphatic carboxylic acids, or alcohols, or both of aliphatic carboxylic acids and alcohols as impurities. The esters may be pure substances, but may also be mixtures of a plurality of compounds. Esters may be formed by binding between one of aliphatic carboxylic acids and one of alcohols or binding between two or more of aliphatic carboxylic acids combined at an arbitrary ratio and two or more of alcohols combined at an arbitrary ratio.

Specific examples of esters of aliphatic carboxylic acids with alcohols include beeswaxes (mixtures mainly formed of myricyl palmitate), stearyl stearate, behenyl. behenate, stearyl behenate, glycerin monopalmitate, glycerin monostearate, glycerin distearate, glycerin tristearate, pentaerythritol monopalmitate, pentaerythritol monostearate, pentaerythritol distearate, pentaerythritol tristearate, and pentaerythritol tetrastearate.

Examples of aliphatic hydrocarbons having a number average molecular weight of from 200 through 15,000 include liquid paraffin, paraffin waxes, microwaxes, polyethylene waxes, Fischer-Tropsch waxes, and α-olefin oligomers containing from 3 through 12 carbon atoms. Particularly, paraffin waxes and polyethylene waxes or partial oxides of polyethylene waxes are preferable, and paraffin waxes and polyethylene waxes are more preferable. Aliphatic hydrocarbons encompass alicyclic hydrocarbons. These hydrocarbons may be partially oxidized.

It is preferable that the number average molecular weight of the aliphatic hydrocarbons be 5,000 or less.

The aliphatic hydrocarbons may be single substances. However, mixtures of ali.phatic hydrocarbons containing different constituent components or having different molecular weights may also be used so long as the main component is any of the aliphatic hydrocarbons presented above.

Examples of polysiloxane-based silicone oils include dimethyl silicone oils, methylphenyl silicone oils, diphenyl silicone oils, and fluorinated alkyl silicones.

One of the lubricants may be used alone or two or more of the lubricants maybe used in combination at an arbitrary ratio.

A content of the lubricant is typically 0.001 parts by mass or greater and preferably 0.01 parts by mass or greater relative to a total of 100 parts by mass of the resin composition in terms of obtaining a sufficient releasing effect, and is typically 2 parts by mass or less and preferably 1 part by mass or less relative to a total of 100 parts by mass of the resin composition in terms of reducing possibilities of degradation of hydrolysis resistance and possibilities of contamination of molds in injection molding.

### —Ultraviolet Absorber—

Examples of the ultraviolet absorber include: inorganic ultraviolet absorbers such as cerium oxide and zinc oxide; and organic ultraviolet absorbers such as benzotriazole compounds, benzophenone compounds, salicylate compounds, cyanoacrylate compounds, triazine compounds, oxanilide compounds, malonic acid ester compounds, and hindered amine compounds. Particularly, organic ultraviolet absorbers are preferable and benzotriazole compounds are more preferable in terms of imparting a favorable transparency and favorable mechanical properties to the resin composition.

Specific examples of benzotriazole compounds include 2-(2′-hydroxy-5′-methylphenyl)benzotriazole, 2-[2′-hydroxy-3′,5′-bis(α,α-diemthylbenzyl)phenyl]-benzotriazole, 2-(2′-hydroxy-3′,5′-di-tert-butyl-phenyl)-benzotriazole, 2-(2′-hydroxy-3′-tert-butyl-5′-methylphenyl)-5-chlorobenzotriazole, 2-(2′-hydroxy-3′,5′-di-tert-butyl-phenyl)-5-chlorobenzotriazole), 2-(2′-hydroxy-3′,5′-di-tert-amyl)-benzotriazole, 2-(2′-hydroxy-5′-tert-octylphenyl)benzotriazole, and 2,2′-methylenebis[4-(1,1,3,3-tetramethylbutyl)-6-(2N-benzotriazol-2-yl)phenol]. Among these benzotriazole compounds, 2-(2′-hydroxy-5′-tert-octylphenyl)benzotriazole, 2,2′-methylenebis[4-(1,1,3,3-tetramethylbutyl)-6-(2N-benzotriazol-2′-yl)phenol] are preferable, and 2-(2′-hydroxy-5′-tert-octylphenyl)benzotriazole is particularly preferable.

Examples of commercially available products of benzotriazole compounds include: “SEESORB 701”, “SEESORB 705”, “SEESORB 703”, “SEESORB 702”, “SEESORB 704”, and “SEESORB 709” available from Shipro Kasei Kaisha, Ltd.; “BIOSORB 520”, “BIOSORB 582”, “BIOSORB 580”, and “BIOSORB 583” available from Kyodo Chemical Co., Ltd.; “KEMISORB 71” and “KEMISORB 72” available from Chemipro Kasei Kaisha, Ltd.; “CYASORB UV5411” available from Cytec Industries Incorporated; “LA-32”, “LA-38”, “LA-36”, “LA-34”, and “LA-31” available from Adeka Corporation; and “TINUVIN P”, “TINUVIN 234”, “TINUVIN 326”, “TINUVIN 327”, and “TINUVIN 328” available from Ciba Specialty Chemicals Inc.

Specific examples of benzophenone compounds include 2,4-dihydmxybenzophenone, 2-hydroxy-4-methoxybenzophenone, 2-hydroxy-4-methoxybenzoplienone-5-sulfonic acid, 2-hydroxy-4-n-octhxybenzophenone, 2-hydroxy-n-dodecyloxybenzophenone, bis(5-benzoyl-4-hydroxy-2-methoxyphenyl)methane, 2,2′-dihydroxy-4-methoxybenzophenone, and 2,2′-dihydroxy-4,4′-dimethoxybenzophenone.

Examples of commercially available products of benzophenone compounds include: “SEESORB 100”, “SEESORB 101”, “SEESORB 1015”, “SEESORB 102”, and “SEESORB 103” available from Shipro Kasei Kaisha, Ltd.; “BIOSORB 100”, “BIOSORB 110”, and “BIOSORB 130” available from Kyodo Chemical Co., Ltd.; “KEMISORB 10”, “KEMISORB 11”, “KEMISORB 11S”, “KEMISORB 12”, “KEMISORB 13”, and “KEMISORB 111” available from Chemipro Kasei Kaisha, Ltd.; “UVINUL 400”, “UVINUL M-40”, and “UVINUL MS-40” available from BASF GmbH; “CYASORB UV9”, “CYASORB UV284”, “CYASORB UV531.”, and “CYASORB UV24” available from Cytec Industries Incorporated; and “ADEKASTAB 1413” and “ADEKASTAB LA-51” available from Adeka Corporation.

Specific examples of salicylate compounds include phenyl salicylate and 4-tert-butylphenyl salicylate. Examples of commercially available products of salicylate compounds include: “SEESORB 201” and “SEESORB 202” available from Shipro Kasei Kaisha, Ltd.; and “KEMISORB 21” and “KEMISORB 22” available from Chemipro Kasei Kaisha, Ltd.

Specific examples of cyanoacrylate compounds include ethyl-2-cyano-3,3-diphenyl acrylate and 2-ethylhexyl-2-cyano-3,3-diphenyl acrylate. Examples of commercially available products of cyanoacrylate compounds include: “SEESORB 501” available from Shipro Kasei Kaisha, Ltd.; “BIOSORB 910” available from Kyodo Chemical Co., Ltd.; “UVISOLATOR 300” available from Daiichi. Kasei Co., Ltd.; and. “UVINUL N-35” and “UVINUL N-539” available from BASF GmbH.

Specific examples of triazine compounds includes compounds having a 1,3,5-triazine skeleton. Examples of commercially available products of triazine compounds include: “LA-46” available from Adeka Corporation; and “TINUVIN 1577ED”, “TINUVIN 400”, “TINUVIN 405”, “TINUVIN 460”, “TINUVIN 477-DW”, and “TINUVIN 479” available from Ciba Specialty Chemicals Inc.

Specific examples of oxanilide compounds include 2-ethoxy-2′-ethyloxanilic acid bisanilide. Examples of commercially available products of oxanilide compounds include “SANDUVOR VSU” available from Clariant AG.

As malonic acid ester compounds, 2-(alkylidene)malonic acid esters are preferable, and 2-(1-arylalkylid.ene)malonic acid esters are more preferable. Examples of commercially available products of malonic acid ester compounds include: “PR-25” available from Clariant Japan K.K.; and “B-CAP” available from Ciba Specialty Chemicals Inc.

A content of the ultraviolet absorber is typically 0.01 parts by mass or greater and preferably 0.1 parts by mass or greater relative to a total of 100 parts by mass of the resin composition of the present invention in terms of obtaining a sufficient effect of improving weather resistance, and is typically 3 parts by mass or less and preferably 1 part by mass or less relative to a total of 100 parts by mass of the resin composition in terms of reducing possibilities of contamination of molds due to, for example, mold deposits.

One of these ultraviolet absorbers may be used alone or two or more of these ultraviolet absorbers may be used in combination at an arbitrary ratio.

### —Dye or Pigment—

Examples of the dye or pigment include inorganic pigments, organic pigments, and organic dyes.

Examples of inorganic pigments include: sulfide-based pigments such as cadmium red and cadmium yellow; silicate-based. pigments such as ultramarine; oxide-based pigments such as titanium oxide, flowers of zinc, red ocher, chromium oxide, iron black, titanium yellow, zinc-iron-based brown, titanium-cobalt-based green, cobalt green, cobalt blue, and copper-chromium-based black, and copper-iron-based black; chromic acid-based pigments such as chrome yellow and molybdate orange; and ferrocyanide-based pigments such as Prussian blue.

Examples of organic pigments and organic dyes include: phthalocyanine-based dyes or pigments such as copper phthalocyanine blue and copper phthalocyanine green; azo-dyes or pigments such as nickel azo yellow; condensed polycyclic dyes or pigments such as thioindigo-based, perinone-based, perylene-based, quinacridone-based, dioxazine-based, isoindolinone-based, and quinophthalone-based dyes or pigments; and anthraquinone-based, heterocyclic-based, and methyl-based dyes or pigments.

Among these dyes or pigments, for example, titanium oxide, and cyanine-based, quinoline-based, anthraquinone-based, and phthalocyanine-based compounds are preferable in terms of thermal stability.

One of these dyes or pigments may be used alone or two or more of these dyes or pigments may be used in combination at an arbitrary ratio.

A content of the dye or pigment is typically 5 parts by mass or less, preferably 3 parts by mass or less, and more preferably 2 parts by mass or less relative to a total of 100 parts by mass of the resin composition of the present invention in terms of obtaining a sufficient impact resistance.

### (Molded Body)

A molded body according to an embodiment of the present invention (hereinafter may also be referred to as “molded body according to an embodiment”) includes the flame-retardant resin composition of the present invention.

Examples of the molded body according to an embodiment include components of information/mobile devices such as computers, notebook or laptop personal computers, tablet terminals, smart phones, and cellular phones and OA apparatuses such as printers and copiers. The molded body according to an embodiment is used particularly suitably as exterior materials that need to have heat resistance.

The molded body according to an embodiment can be obtained by injection-molding the flame-retardant resin composition according to an embodiment by a usual method.

### (Electronic Component and Electronic Apparatus)

An electronic component according to an embodiment of the present invention includes the molded body of the present invention.

An electronic apparatus according to an embodiment of the present invention includes the molded body of the present invention.

Examples of the electronic component include electronic components of information/mobile devices such as computers, notebook or laptop personal computers, tablet terminals, smart phones, and cellular phones and OA apparatuses such as printers and copiers.

Examples of the electronic apparatus include information/mobile devices such as computers, notebook or laptop personal computers, tablet terminals, smart phones, and cellular phones and OA apparatuses such as printers and copiers.

### (Electronic Office Apparatus)

An electronic office apparatus of the present invention includes a flame-retardant resin molded body that has passed a burning test of a UL94-V2 level or higher, and the molded body of the present invention. The molded body of the present invention is disposed below the flame-retardant resin molded body by a distance of 0.0001 cm or greater but less than 3 cm.

### (Method for Producing Flame-Retardant Resin Composition)

A method for producing a flame-retardant resin composition according to an embodiment of the present invention (hereinafter may also be referred to as “producing method according to an embodiment”) includes, for example, a melting and kneading step of melting and kneading PC, a phosphazene derivative, and a phosphoric acid ester, components to be added optionally and selectively, and other additives to be added as needed, and a gap passing process step of performing a process of passing the kneaded flame-retardant resin composition through a gap between two surfaces (here, a surface-to-surface dimension of the gap in a cross-section in the direction in which the resin composition flows is from 0.1 mm through 5 mm).

In the present invention, the object of the present invention can be achieved with only the melting and kneading step alone. It is more preferable to add the gap passing process step.

### <Melting and Kneading Step>

In the producing method according to an embodiment, first, the components needed in the present invention, components to be added optionally and selectively, and other additives to be added as needed are melted and kneaded (a melting and kneading step).

In the step described above, the components can be mixed uniformly.

In this step, the components described above are kneaded with a kneading device known in the pertinent technical field such as a tumbler, a Henschel mixer, a Banbury mixer, a roll, a Brabender, a uniaxial kneader/extruder, a biaxial kneader/extruder, and a kneader with appropriate adjustment of conditions such as a kneading speed, a kneading temperature, and a kneading time.

For example, the components described above may be pre-mixed with, for example, a tumbler or a Henschel mixer, and then melted and kneaded with a kneading device such as a Banbury mixer, a roll, a Brabender, a uniaxial kneader/extruder, a biaxial kneader/extruder, and a kneader. Alternatively, for, example, without being pre-mixed, the components may be fed into an extruder using a feeder to be melted and kneaded. Yet alternatively, only part of the components may be pre-mixed and then melted and kneaded, and a resin composition obtained as a result may be used as a masterbatch with which the remaining part of the components are melted and kneaded.

This step is not particularly limited, and it is also preferable to previously melt and mix the optionally selected components and then feed these components to a biaxial kneader/extruder. When the phosphoric acid ester is liquid at room temperature, it is possible to dissolve the is phosphazene derivative in this component at room temperature. When the phosphoric acid ester is solid (e.g., powder) at room temperature, it is possible to mix these components with a mortar, heat the mixture to 90 degrees C. or higher to melt the mixture, and feed the mixture in the melted state to a biaxial kneader/extruder.

The pre-mixing of the phosphoric acid ester and the phosphazene derivative is an example of the melting and kneading step, and is a preferable embodiment in terms of improving dispersibility of the flame retardant. The pre-mixing is not indispensable in the producing method of the present invention. The mixing with a mortar is an example of a mixing method, and the mixing method in the producing method of the present invention is not limited to this mixing method but may be any method.

Particularly, the kneading temperature is determined based on a melting temperature (Tm) of the PC. Like a glass transition temperature (Tg), a melting temperature (Tm) may be measured with any device such as DSC, TMA, DTA, and a temperature variable viscoelasticity device. The flame-retardant resin composition of the present invention can be easily obtained when kneading is performed at a temperature equal to or higher than Tm measured with these devices.

At a temperature lower than Tin, a shear flow acts effectively to inhibit formation of domains of the phosphazene derivative. Particularly, a favorable result can be obtained in the present invention in a kneading temperature range of from lower than Tm through Tg+20 degrees C.

It is known that Tm and Tg vary depending on the measuring method. In the present invention, it is preferable to use Tm and Tg values measured by DSC.

The device used in the kneading step is preferably a biaxial extruder in terms of producing a resin composition in a large amount stably, i.e., in terms of production efficiency.

### <Gap Passing Process Step>

Next, a process of passing a flame-retardant resin composition after kneaded through a gap between two surfaces is performed (here, a surface-to-surface dimension of the gap in a cross-section in the direction in which the resin composition flows is from 0.1 mm through 5 min) (a gap passing process step).

In the step described above, a continuous laminar shear flow occurs in the resin composition through passing through the gap and efficiently disperses and mixes the resin composition (chaotic mixing). This makes it possible to perform kneading while avoiding damages to the resin, such as a molecular weight reduction. This results in an improved dispersibility in the resin composition, of the phosphazene derivative and the phosphoric acid ester that serve to impart flame retardancy to the resin composition, leading to an improved flame retardancy of the resin composition.

In this step, for example, a die internally including a space that is sandwiched between two surfaces and through which the resin composition can be passed is used when a bidirectional kneader/extruder is used in the kneading step described above. The die is attached at a discharging port of the biaxial kneader/extruder. The die to be used includes two or more gaps each having a surface-to-surface dimension of from 0.1 mm through 5 mm in a cross-section in the direction in which the resin composition flows. The resin composition after kneaded is extruded from the discharging port of the biaxial. kneaderfextruder into the die. The extruded resin composition is processed through passing through the internal space of the die, and extruded from the discharging port of the die.

The surface-to-surface dimension is preferably 0.1 mm or greater and more preferably 0.2 mm or greater in terms of preventing clogging of the gap, and is preferably 5 mm or less and more preferably 3 mm or less in terms of obtaining a favorable kneading effect.

The length of the gap in the direction in which the resin composition flows is preferably 5 mm or greater and more preferably 10 mm or greater, and is preferably 100 mm or less and more preferably 50 mm or less in terms of obtaining a sufficient kneading effect.

The width of the gap in the direction perpendicular to the direction in which the resin composition flows is not particularly limited, and, for example, may be 5 mm or greater or may be greater than 2,000 mm.

Examples of the two surfaces include plane surfaces, curved. surfaces, and combination of a plane surface and a curved surface. Curved surfaces are particularly preferable in terms of avoiding damages to the resin. Specifically, the surface-to-surface dimension of preferable curved surfaces in a cross-section in the direction in which the resin composition flows gradually decreases from the start in the flow direction toward the center of the gap and then gradually increases from the center of the gap toward the end in the flow direction.

The number of gaps through which the resin composition is passed is preferably 2 or greater.

Examples of the device used in the gap passing process step include the devices described in Japanese Unexamined Patent Application Publication Nos. 2011-26364 and 2013-028795.

As described above, according to the method for producing a flame-retardant resin composition according to an embodiment of the present invention, it is possible to produce the flame-retardant resin composition according to an embodiment of the present invention excellent particularly in flame retardancy, stiffness, and impact resistance.

### EXAMPLES

Examples of the present invention will be described below. However, the present invention should not be construed as being limited to these Examples.

### [Raw Materials]

### —PC (Polycarbonate)—

PC: TAFLON A2200 available from Idemitsu Kosan Co., Ltd.

PC (R): commercially available recycled PC, a product recycled from water bottles, with a weight average molecular weight of 25,000

### —Other Thermoplastic Resins—

ABS (acrylonitrile butadiene styrene resin): TECHNO ABS300 available from Techno Polymer Co., Ltd.

PS (polystyrene): available from PS Japan Corporation, product name: GPPS

PET (polyethylene terephthalate): commercially available recycled PET, a product recycled from PET bottles for drinks, with a viscosity of 0.8 dl/g

PL (polylactic acid): a polylactic acid resin available from Mitsui Chemicals, Inc., RACIA H-100J

PA (nylon): a nylon resin AMILAN CM1007 available from Toray Industries, Inc.,

PEN (polyethylene naphthalate): TEONEX available from Teijin Limited

### —Phosphazene Derivative in Which a Group Containing at Least One Aromatic Group is Substituted in All or Part of Side Chains—

SPS100: SPS100 available from Otsuka Chemical Co., Ltd. (an aromatic phosphazene compound containing a three-membered ring structure as a main component and 6 side chains, all of which are phenoxy groups)

### —Phosphorus-Containing Compound Containing at Least One Aromatic Ring—

TPP: TPP available from Daihachi Chemical Industry Co., Ltd., (SP value: 22 (MPa)1/2)

BDP: FYROLFLEX BDP (bisphenol A bis(diphenylphosphate)) available from Polymate Additives Co., Limited, (SP value: 21.8 (MPa)1/2))

The SP values were measured with software OCTA (SP values of other components were also measured in the same manner).

The following compounds were used. as other phosphorus-containing compounds.

TMP: TMP (trimethyl phosphate) available from Daihachi Chemical industry Co. Ltd., (SP value: 16.5 (MPa)1/2)

Red phosphorus: highly-pure red phosphorus available from Nippon Chemical. Industrial Co., Ltd.

### —Fluororesin—

METHABRENE A-3800: a PTFE modified product available from Mitsubishi Rayon Co., Ltd.

### —Other Additives—

C-223A: METHABRENE C-223A available from Mitsubishi Rayon Co., Ltd. as a resin additive (a reformer for kneading PC, PS, PBT, and PA)

S-2001: METHABRENE available from Mitsubishi Rayon Co., Ltd. as a resin additive (a reformer for kneading PC, PET, and PA)

### [Method for Measuring Physical Properties]

Flame-retardant resin compositions produced in Examples and Comparative Examples described below were injection-molded with an injection molder EC50SX available from Toshiba Machine Co., Ltd. at a molding temperature of 280 degrees C. at an injection speed of 50 mm/s at an injection pressure of 85 Pa, to produce ISO multi-purpose test samples. The following tests (1) to (3) were conducted using these test to samples.

### (1) Flame Retardancy Test

The ISO multi-purpose test sample obtained as described above was humidified in a thermostatic chamber having a temperature of 23 degrees C. and a humidity of 50 percent for 48 hours and subjected to a flame retardancy test according to a UL94 test (a burning test for plastic materials for device components) stipulated by United States Underwriters Laboratories (UL).

UL94V is a method for evaluating flame retardancy by bringing a test sample held vertically and having a predetermined size into contact with a flame of a burner for 10 seconds to examine a lingering flame time and cotton ignitability due to drip. A lingering flame time refers to a length of a time for which the test sample continues flaming since the ignition source is separated from the test sample. Cotton ignitability due to drip refers to a property determined by whether cotton for labeling located about 300 mm below the lower end of the test sample is ignited by a dripping matter (drip) from the test sample. The test result is evaluated according to the evaluation criteria presented in Table 1 below.

TABLE 1

| | V-0 | V-1 | V-2 |
|---|---|---|---|
| Lingering flame time | 10 seconds | 30 seconds | 30 seconds |
| of one test sample | or less | or less | or less |
| Lingering flame time | 50 seconds | 250 seconds | 250 seconds |
| of five test samples | or less | or less | or less |
| Cotton ignitability | Not ignited | Not ignited | Ignited |
| due to drip | | | |

Limiting oxygen index (LOI) was measured according to ISO4589-2.

### (2) Tensile Test

The ISO multi-purpose test sample (4 mmt) obtained as described above was subjected to a tensile test according to ISO1.78. A test sample having a higher measured value (MPa) was evaluated as better at stiffness (tensile strength).

### (3) Impact Test

The ISO multi-purpose test sample (3 mmt) obtained as described above was subjected to an impact test using an Izod impact tester. A notch (slit) was cut out in the test sample. A test sample having a higher measured value (J/m) was evaluated as better at impact resistance.

### (4) Deflection Temperature Under Load (HDT)

HDT was measured according to a method compliant with ASTM-D648 using a 6.35 min (¼ inch) test sample under 1.82 MPa.

Examples and Comparative Examples will be described in detail below.

### Example 1

As a biaxial kneader/extruder, HYPERKTX 46 (hereinafter may also be referred to as “KTX 46”) available from Kobe Steel, Ltd. was used. A die (a gap processing device) available from Kodaira Seisakusho Co., Ltd. was attached at the tip of the discharging port of KTX 46. A feeder and a pelletizer, which were attachments of KTX 46, were synchronized in a manner that an amount of the resin to be discharged from the biaxial kneader/extruder would be 100 kg/hour. A water tank having a length of 3 m was set in front of the pelletizer for cooling a strand.

The gap processing device had 3 gaps each designed to have a surface-to-surface dimension of 1 mm, a gap width of 400 mm, and a gap length of 20 mm. The device was used in a state of being set at 250 degrees C. This device was a chaotic mixing device. Whether this device was used in other Examples and Comparative Examples is indicated in Table 2 to Table 4 as “used” when the device was used or “not used” when the device was not used.

A screw segment of the biaxial kneader/extruder KTX 46 was designed to have rotor segments at 2 positions and operated at a rotation speed of 300 rpm at a kneading temperature of 260 degrees C.

BDP (0.6 kg) was heated to 90 degrees C., and SPS1.00 (0.32 kg) was dissolved in the BDP. PC (10 kg), PET (polymer A) (0.2 kg), METHABRENE A-3800 (fluororesin) (0.02 kg), and S-2001 (one of the other additives) (0.03 kg) were added under stirring into the BDP and the SPS100 that were in the dissolved state. Then, the mixture (resin composition) was cooled to room temperature.

The obtained resin composition was stirred at room temperature for a while. When the surface of the resin composition started to dry, the resin composition was fed into the feeder of the biaxial kneader/extruder, kneaded, and extruded from the discharging port of the die.

A pellet of the flame-retardant resin composition of an Example of the present invention was produced under predetermined operation conditions. The pellet was dried at 80 degrees C. for 5 hours.

The flame-retardant resin composition obtained in this way was subjected to the evaluations (1) to (4) described above. As a result, as for flame retardancy, the sample passed UL94-V0 without deformation in the burning test, and LOI was 24.5. The portion burned in the UL test was cut out by 1 cm to measure D1/D0, which was 1.05 (average of 5 samples). This means that the weight had increased as a result of burning. The tensile strength was 65 MPa (average of 5 samples), and the impact strength was 140 J/M. The deflection temperature under load was 97 degrees C. The details of the component composition and evaluation results are presented in Table 2.

### Examples 2 and 6

Flame-retardant resin compositions were produced in the same manner as in Example 1, except that PC (R) was used instead of PC, TPP was used instead of BDP, the kneading temperature was 250 degrees C., and the component composition was as presented in Table 2. The resin compositions were subjected to testing in the same manner as in Example 1. The details of the component composition and evaluation results are 1, 0 presented in Table 2.

### Examples 3 to 5

Flame-retardant resin compositions were produced in the same manner as in Example 1, except that red phosphorus was previously kneaded with ABS (polymer. A), the kneading temperature was 250 degrees C., and the component composition was as presented in Table 2. The resin compositions were subjected to testing in the same manner as in Example 1. The details of the component composition and evaluation results are presented in Table 2. Note that the component composition in Table 2 is presented as a blending ratio in the final composition.

### Example 7

A flame-retardant resin composition was produced in the same manner as in Example 1, except that nylon 6 (PA) was used as a polymer A, the kneading temperature was 250 degrees C., and the component composition was as presented in Table 3. The resin composition was subjected to testing in the same manner as in Example 1. The details of the component composition and evaluation results are presented in Table 3.

### Example 8

A flame-retardant resin composition was produced in the same manner as in Example 1, except that a polylactic acid (PL) was used as a polymer A, the kneading temperature was 250 degrees C., and the component composition was as presented in Table 3. The resin composition was subjected to testing in the same manner as in Example 1. The details of the component composition and evaluation results are presented in Table 3.

### Example 9

A flame-retardant resin composition was produced in the same manner as in Example 1, except that nylon 6 (PA) was used as a polymer A, one of the other additives (C-223A) was used, the kneading temperature was 250 degrees C., and the component composition was as presented in Table 3. The resin composition was subjected to testing in the same manner as in Example 1. The details of the component composition and evaluation results are presented in Table 3.

### Example 10

A flame-retardant resin composition was produced in the same manner as in Example 1, except that PET was used as a polymer A, PEN was used as a polymer other than A, the kneading temperature was 250 degrees C., and the component composition was as presented in Table 3. The resin composition was subjected to testing in the same manner as in Example 1. The details of the component composition and evaluation results are presented in Table 3.

### Example 11

A flame-retardant resin composition was produced in the same o manner as in Example 1., except that ABS to which red phosphorus was added in an amount of 10 percent by mass was used as a polymer A, PS was used as a polymer other than A, the kneading temperature was 250 degrees C., and that the component composition was as presented in Table 3. The resin composition was subjected to testing in the same manner as 7.5 in Example 1. The details of the component composition and evaluation results are presented in Table 3.

### Example 12

A flame-retardant resin composition was produced in the same manner as in Example 1, except that ABS to which red phosphorus was added in an amount of 10 percent by mass was used as a polymer A, PEN was used as a polymer other than A, the kneading temperature was 250 degrees C., and that the component composition was as presented in Table 3. The resin composition was subjected to testing in the same manner as in Example 1. The details of the component composition and evaluation results are presented in Table 3.

### Comparative Examples 1 to 5

Flame-retardant resin compositions were produced in the same manner as in Example 1, except that the component composition was as presented in Table 4. The resin compositions were subjected to testing in the same manner as in Example 1. In particular, in Comparative Example 3, TMP was used as a phosphoric acid ester-based flame retardant. The details of the component composition and evaluation results are presented in Table 4.

TABLE 2

| | | | Ex. 1 | Ex. 2 | Ex. 3 | Ex. 4 | Ex. 5 | Ex. 6 |
|---|---|---|---|---|---|---|---|---|
| Polymer | PC (kg) | | 10 | 10 | 10 | 10 | 10 | 10 |
| | Polymer A (kg) | | 0.2 | 5.5 | 4 | 5 | 7.5 | 0.5 |
| | Polymer other than A (kg) | | | | | | | |
| PN | Phosphazene derivative | | SPS100 | SPS100 | SPS100 | SPS100 | SPS100 | SPS100 |
| | Phosphazene derivative (kg) | | 0.32 | 0.3 | 0.02 | 0.35 | 0.4 | 0.33 |
| | Phosphazene derivative (content | | 2.86 | 1.67 | 0.13 | 2.07 | 2.05 | 2.96 |
| | rate: percent by mass) | | | | | | | |
| PO | Phosphoric acid ester | | BDP | TPP | BDP | BDP | BDP | TPP |
| | Phosphoric acid ester (kg) | | 0.6 | 2.1 | 0.8 | 1.5 | 1.5 | 0.3 |
| | Phosphoric acid ester (content | | 5.37 | 11.69 | 5.11 | 8.85 | 7.69 | 2.69 |
| | rate: percent by mass) | | | | | | | |
| P | Other phosphorus compound | | | | Red | Red | Red | |
| | | | | | phosphorus | phosphorus | phosphorus | |
| | Other phosphorus compound (kg) | | | | 0.8 | 0.05 | 0.075 | |
| F | Fluororesin (kg) | | 0.02 | 0.07 | 0.04 | 0.04 | 0.02 | 0.02 |
| Others | Other additives (kg) | | 0.03 | | | | | |
| Total (kg) | | | 11.17 | 17.97 | 15.66 | 16.94 | 19.495 | 11.15 |
| PC content rate (percent by mass) | | | 89.5 | 55.6 | 63.9 | 59 | 51.3 | 89.7 |
| Chaotic mixing device | | | Used | Used | Used | Used | Used | Used |
| Test | (1) | LOI | 24.5 | 24 | 25 | 24 | 24 | 24 |
| | | UL94•V0 pass or fail | Pass | Pass | Pass | Pass | Pass | Pass |
| | | Deformation in burning | Absent | Absent | Absent | Absent | Absent | Absent |
| | | D1/D0 | 1.05 | 0.90 | 0.89 | 0.95 | 0.96 | 1.02 |
| | (4) | Deflection temperature | 97 | 92 | 105 | 97 | 91 | 96 |
| | | under load (degrees C.) | | | | | | |
| | (3) | Izod impact strength (J/M) | 140 | 120 | 60 | 80 | 65 | 160 |
| | (2) | Tensile strength (MPa) | 65 | 64 | 62 | 62 | 63 | 64 |

TABLE 3

| | | | Ex. 7 | Ex. 8 | Ex. 9 | Ex. 10 | Ex. 11 | Ex. 12 |
|---|---|---|---|---|---|---|---|---|
| Polymer | PC (kg) | | 10 | 10 | 10 | 10 | 10 | 10 |
| | Polymer A (kg) | | 0.5 | 0.5 | 0.5 | 0.5 | 2 | 2 |
| | Polymer other than A (kg) | | | | | 0.3 | 0.5 | 0.3 |
| PN | Phosphazene derivative | | SPS100 | SPS100 | SPS100 | SPS100 | SPS100 | SPS100 |
| | Phosphazene derivative (kg) | | 0.3 | 0.3 | 0.3 | 0.3 | 0.32 | 0.35 |
| | Phosphazene derivative (content | | 2.58 | 2.53 | 2.58 | 2.51 | 2.40 | 2.66 |
| | rate: percent by mass) | | | | | | | |
| PO | Phosphoric acid ester | | TPP | TPP | TPP | TPP | TPP | TPP |
| | Phosphoric acid ester (kg) | | 0.8 | 1 | 0.8 | 0.8 | 0.3 | 0.3 |
| | Phosphoric acid ester (content | | 6.88 | 8.42 | 6.87 | 6.69 | 2.25 | 2.28 |
| | rate: percent by mass) | | | | | | | |
| P | Other phosphorus compound | | | | | | Red | Red |
| | | | | | | | phosphorus | phosphorus |
| | Other phosphorus compound (kg) | | | | | | 0.2 | 0.2 |
| F | Fluororesin (kg) | | 0.02 | 0.02 | 0.02 | 0.02 | 0.02 | 0.02 |
| Others | Other additives (kg) | | | 0.05 | 0.03 | 0.03 | | |
| Total (kg) | | | 11.62 | 11.87 | 11.65 | 11.95 | 13.34 | 13.18 |
| PC content rate (percent by mass) | | | 86.1 | 84.2 | 85.8 | 83.7 | 75.0 | 75.9 |
| Chaotic mixing device | | | Used | Used | Used | Used | Not | Not |
| | | | | | | | used | used |
| Test | (1) | LOI | 24 | 24.5 | 24 | 24 | 24 | 24 |
| | | UL94•V0 pass or fail | Pass | Pass | Pass | Pass | Pass | Pass |
| | | Deformation in burning | Absent | Absent | Absent | Absent | Absent | Absent |
| | | D1/D0 | 0.95 | 0.92 | 0.89 | 0.95 | 1.00 | 1.02 |
| | (4) | Deflection temperature | 98 | 92 | 95 | 97 | 99 | 97 |
| | | under load (degrees C.) | | | | | | |
| | (3) | Izod impact strength (J/M) | 95 | 85 | 75 | 80 | 60 | 100 |
| | (2) | Tensile strength) (MPa) | 63 | 64 | 62 | 63 | 64 | 64 |

TABLE 4

| | | | Comp. | Comp. | Comp. | Comp. | Comp. |
|---|---|---|---|---|---|---|---|
| | | | Ex. 1 | Ex. 2 | Ex. 3 | Ex. 4 | Ex. 5 |
| Polymer | PC (kg) | | 10 | 6.5 | 10 | 10 | 10 |
| | Polymer A (kg) | | 0 | 5 | 5.5 | 5 | 0.5 |
| | Polymer other than A (kg) | | | | | | |
| PN | Phosphazene derivative | | SPS100 | SPS100 | | SPS100 | |
| | Phosphazene derivative (kg) | | 0.35 | 0.3 | | 1.2 | |
| | Phosphazene derivative (content | | 3.38 | 2.25 | | 6.59 | |
| | rate: percent by mass) | | | | | | |
| PO | Phosphoric acid ester | | | TPP | TMP | TPP | TPP |
| | Phosphoric acid ester (kg) | | | 1.5 | 2.8 | 2 | 0.8 |
| | Phosphoric acid ester (content | | | 11.26 | 15.28 | 10.98 | 6.49 |
| | rate: percent by mass) | | | | | | |
| P | Other phosphorus compound | | | | | | |
| | Other phosphorus compound (kg) | | | | | | |
| F | Fluororesin (kg) | | 0.02 | 0.02 | 0.02 | 0.02 | 0.02 |
| Others | Other additives (kg) | | | | | | 1 |
| Total (kg) | | | 10.37 | 13.32 | 18.32 | 18.22 | 12.32 |
| PC content rate (percent by mass) | | | 96.4 | 48.8 | 54.6 | 54.9 | 81.2 |
| Chaotic mixing device | | | Not | Not | Not | Not | Not |
| | | | used | used | used | used | used |
| Test | (1) | LOI | 21.5 | 23.5 | 24 | 24.5 | 23.5 |
| | | UL94•V0 pass or fail | Fail | Fail | Fail | Pass | Fail |
| | | Deformation in burning | Absent | Present | Present | Present | Present |
| | | D1/D0 | 1.03 | 0.81 | 0.84 | 0.83 | 0.60 |
| | (4) | Deflection temperature | 95 | 89 | 87 | 89 | 96 |
| | | wider load (degrees C.) | | | | | |
| | (3) | Izod impact strength (J/M) | 60 | 35 | 42 | 35 | 40 |
| | (2) | Tensile strength (MPa) | 66 | 56 | 59 | 60 | 62 |

The present invention can provide a flame-retardant resin composition excellent particularly in flame retardancy, stiffness, and impact resistance. The present invention can provide a molded body excellent particularly in flame retardancy, stiffness, and impact resistance. The flame-retardant resin composition of the present invention and the molded body of the present invention can be used particularly suitably for exterior materials that need to have heat resistance, such as materials for information/mobile devices such as computers, notebook or laptop personal computers, tablet terminals, smart phones, and cellular phones and OA apparatuses such as printers and copiers. The present invention can also provide a method for producing the flame-retardant resin composition of the present invention.

Aspects of the present invention are as follows, for example.
<1> A resin composition including:
a polycarbonate; and
a phosphorus-containing compound,
wherein a content rate of the phosphorus containing compound in the resin composition is less than 14 percent by mass,
wherein the phosphorus-containing compound includes a phosphazene derivative represented by general formula (1) below and a phosphoric acid ester,
wherein a content rate of the phosphazene derivative in the resin composition is 0.1 percent by mass or greater but less than 3.0 percent by mass, and
wherein a resin specific gravity (D0) of the resin composition before burned in a UL94V test and a resin specific gravity (D1) of the resin composition after burned in the UL94V test satisfy a relationship of D1/D0>0.85,

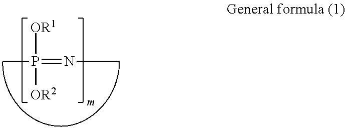

where in general formula (1), R¹ and R² each independently represent an aromatic ring-containing group free of a halogen atom, and m represents any of from 3 through 8.
<2> The resin composition according to <1>,
wherein the phosphoric acid ester is a compound represented by general formula (2) below,

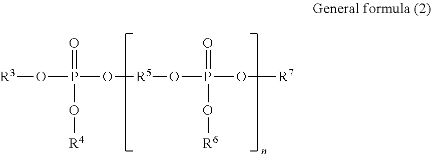

where in general formula (2), R³ to R⁷ each independently represent an aromatic ring-containing group, and n represents any of from 1 through 10,000.
<3> The resin composition according to <1> or <2>,
wherein a deflection temperature under load (ASTM-D648) of the resin composition is 90 degrees C. or higher under 1.82 MPa.
<4> The resin composition according to any one of <1> to <3>, further including
a polymer containing red phosphorus in an amount of 1 percent by mass or greater but less than 20 percent by mass.
<5> The resin composition according to any one of <1> to <4>, further including
a fl.uororesin in an amount of less than 0.5 percent by mass.
<6> A molded body including
the resin composition according to any one of <1> to <5>,
wherein the molded body is formed of the resin composition.
<7> An electronic component including
the molded body according to <6>.
<8> An electronic apparatus including
the molded body according to <6>.
<9> An electronic office apparatus including:
a flame-retardant resin molded body that has passed a burning test of a UL94-V2 level or higher; and.

the molded body according to <6>,
the molded body being disposed below the flame-retardant resin molded body by a distance of 0.0001 cm or greater but less than 3 cm.

The present invention can solve the various problems in the related art and can provide a resin composition excellent particularly in flame retardancy, stiffness, and impact resistance.

What is claimed is:

1. A resin composition comprising:
a polycarbonate; and
a phosphorus-containing compound,
wherein a content rate of the phosphorus-containing compound in the resin composition is less than 14. percent by mass,
wherein the phosphorus-containing compound comprises a phosphazene derivative represented by general formula (1) below and a phosphoric acid ester,
wherein a content rate of the phosphazene derivative in the resin composition is 0.1 percent by mass or greater but less than 3.0 percent by mass, and
wherein a resin specific gravity (D0) of the resin composition before burned in a UL94V test and a resin specific gravity (D1) of the resin composition after burned in the UL94V test satisfy a relationship of D1/D0>0.85, 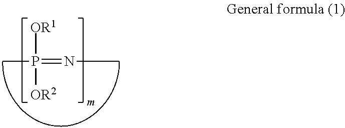
where in general formula (1), R¹ and R² each independently represent an aromatic ring-containing group free of a halogen atom, and m represents any of from 3 through 8.

2. The resin composition according to claim 1,
wherein the phosphoric acid ester comprises a compound represented by general formula (2) below, 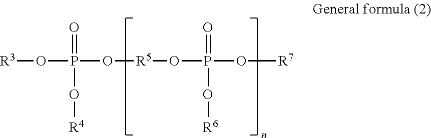
where in general formula (2), R³ to R⁷ each independently represent an aromatic ring-containing group, and n represents any of from 1 through 10,000.

3. The resin composition according to claim 1,
wherein a deflection temperature under load (ASTM-D648) of the resin composition is 90 degrees C. or higher under 1.82 MPa.

4. The resin composition according to claim 1, further comprising a polymer that comprises red phosphorus in an amount of 1 percent by mass or greater but less than 20 percent by mass.

5. The resin composition according to claim 1, further comprising a fluororesin in an amount of less than 0.5 percent by mass.

6. A molded body comprising
the resin composition according to claim 1,
wherein the molded body is formed of the resin composition.

7. An electronic component comprising
the molded body according to claim 6.

8. An electronic apparatus comprising
the molded body according to claim 6.

9. An electronic office apparatus comprising:
a flame-retardant resin molded body that has passed a burning test of a UL94-V2 level or higher; and
the molded body according to claim 6,
the molded body being disposed below the flame-retardant resin molded body by a distance of 0.0001 cm or greater but less than 3 cm.
